(19) United States
(12) Patent Application Publication
(10) Pub. No.: US 2026/0346607 A1
(43) Pub. Date: Nov. 5, 2026

(54) FLOW PATH MEMBER, MANUFACTURING METHOD OF FLOW PATH MEMBER, AND LIQUID EJECTION HEAD

(71) Applicant: CANON KABUSHIKI KAISHA, Tokyo (JP)

(72) Inventor: KENJI TAMAMORI, Kanagawa (JP)

(21) Appl. No.: 19/657,402

(22) Filed: Apr. 24, 2026

(30) Foreign Application Priority Data
May 2, 2025 (JP) 2025-076854

(51) Int. Cl. B41J 2/165; B41J 2/14; B41J 2/16

(52) U.S. Cl. CPC B41J 2/16502; B41J 2/14233; B41J 2/1433; B41J 2/161; B41J 2/1623; B41J 2/1626; B41J 2002/14241; B41J 2002/14306; B41J 2002/14362; B41J 2002/14419

(57) ABSTRACT

A flow path member having: a first substrate having a first flow path; a second substrate having a second flow path and stacked on the first substrate; a film member arranged between the first substrate and the second substrate, in which a plurality of through holes that allow the first flow path and the second flow path to communicate with each other are included; and an adhesive that adheres the first substrate and the film member, wherein a liquid flows from the first flow path to the second flow path via the through holes, wherein an inner wall of the through holes includes a region where a diameter becomes smaller from the first substrate side toward the second substrate side, and wherein at least one through hole among the plurality of through holes is blocked by the adhesive that has entered at least a part of the region.

### BACKGROUND

### Field of the Technology

The present disclosure relates to a flow path member used for a liquid ejection head or the like, a manufacturing method of the flow path member, and a liquid ejection head using the flow path member.

### DESCRIPTION OF THE RELATED ART

As a liquid ejection apparatus, for example, an inkjet liquid ejection apparatus is an apparatus that ejects ink from nozzles of a liquid ejection head that ejects a liquid to perform printing on a medium. In the liquid ejection head, there is a case where a foreign matter in the liquid blocks an ejection port of the liquid ejection apparatus, thereby causing a defect in liquid ejection. As a method for suppressing such an ejection failure, there is a method of installing a filter having through holes smaller than the liquid ejection port in a liquid flow path. For example, Japanese Patent Laid-Open No. 2024-071153 proposes a liquid ejection head having a structure in which a filter having through holes is adhered to a flow path substrate with an adhesive.

Depending on the through hole of the filter of the flow path member, there is a case where the through hole of the filter is blocked by surplus adhesive, and the surplus adhesive is difficult to be retained in the hole. For this reason, there has been a concern that a meniscus of the adhesive peels off and becomes a foreign matter in the liquid on a downstream side of the filter.

### SUMMARY

There is a need for a flow path member that suppresses a surplus adhesive that has entered a through hole of a filter of the flow path member from peeling off and becoming a foreign matter in a liquid on a downstream side of the filter.

A flow path member according to the present disclosure is a flow path member including: a first substrate having a first flow path; a second substrate having a second flow path and stacked on the first substrate; a film member arranged between the first substrate and the second substrate, in which a plurality of through holes that allow the first flow path and the second flow path to communicate with each other are included; and an adhesive that adheres the first substrate and the film member, in which a liquid flows from the first flow path to the second flow path via the through holes, in which an inner wall of the through holes includes a region where a diameter becomes smaller from the first substrate side toward the second substrate side, and in which at least one through hole among the plurality of through holes is blocked by the adhesive that has entered at least a part of the region.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing a flow path member according to a first embodiment of the present disclosure, in which FIG. 1(a) is a cross-sectional view of the flow path member, and FIG. 1 (b) is a plan view taken along line Ib-Ib of FIG. 1A;

FIGS. 2 (a) to (e) are cross-sectional views showing a through hole of a filter according to the first embodiment of the present disclosure;

FIGS. 3 (a) to (g) are cross-sectional views showing a state of an adhesive in the through hole of the filter according to the first embodiment of the present disclosure;

FIGS. 4 (a) to (g) are cross-sectional views showing a manufacturing method of the flow path member of the present disclosure;

FIG. 5 is a perspective view of a liquid ejection head of the present disclosure; and

FIGS. 6 (a) and (b) are a cross-sectional view of a comparative example for describing a filter of a liquid ejection head.

### DESCRIPTION OF THE EMBODIMENTS

In a liquid ejection head, a liquid ejection failure may occur due to a foreign matter in a liquid blocking an ejection port. In order to suppress such a failure, there is a method of installing a filter having through holes smaller than a liquid ejection port in a liquid flow path. For example, a liquid ejection head having a structure in which a filter having through holes is adhered to a flow path substrate with an adhesive has been proposed. In this liquid ejection head, a surplus adhesive enters vertical filter through holes. In the liquid ejection head having such a filter, in a case where an inner wall of the through holes is vertical (a diameter of the hole does not change in a thickness direction of the filter), the through hole of the filter may be difficult to be blocked by the surplus adhesive. Regarding the surplus adhesive blocking this through hole, there is a concern that the adhesive peels off due to a flow of the liquid and becomes a foreign matter in the liquid on a downstream side of the filter.

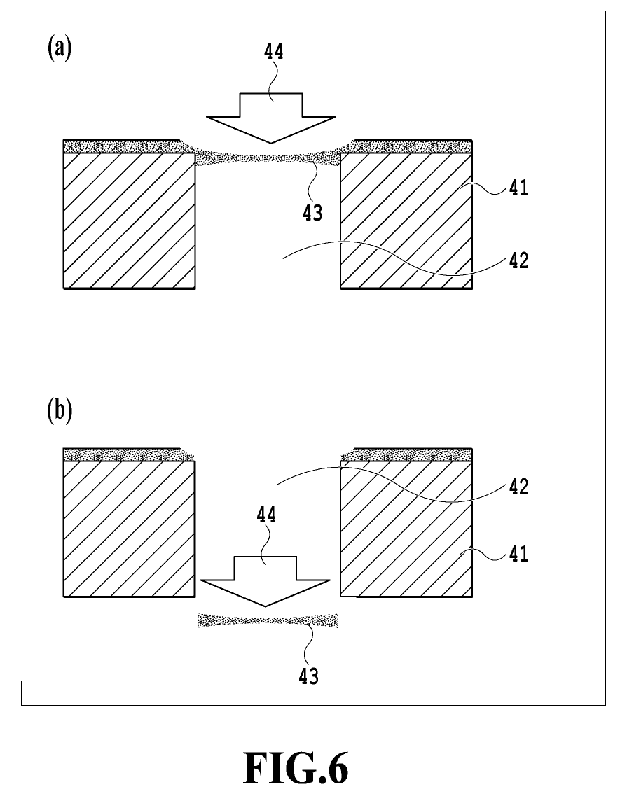

Regarding the above point, a case where the surplus adhesive forms a meniscus in the through hole of the filter and blocks the through hole will be described using FIG. 6 as a comparative example to the present disclosure. FIG. 6 (a) shows a state in which a meniscus of an adhesive 43 is formed in a through hole 42 of a filter 41 to block the through hole 42. In the through hole 42, the liquid flows in a direction of a liquid flow 44 from an upstream side (upper side in the drawing sheet) to a downstream side (lower side in the drawing sheet). As shown in FIG. 6 (a), an inner wall of the through holes 42 of the filter 41 is vertical, and does not have a structure that supports the meniscus of the adhesive 43 from the downstream side (lower side in the drawing sheet). For this reason, as shown in FIG. 6 (b), there is a concern that the meniscus of the adhesive 43 peels off due to the liquid flow 44 and becomes a foreign matter in the liquid on the downstream side of the filter. For example, in a case where pressurization and suction operations are performed as a recovery operation of the liquid ejection head, in the flow path member having the above filter, there is a concern that the meniscus of the adhesive peels off from the through hole and becomes a foreign matter in the liquid on the downstream side of the filter, causing an ejection failure of the liquid.

The present disclosure is directed to a flow path member capable of suppressing a surplus adhesive that has entered a through hole of a filter of the flow path member from peeling off and becoming a foreign matter in a liquid on a downstream side of the filter.

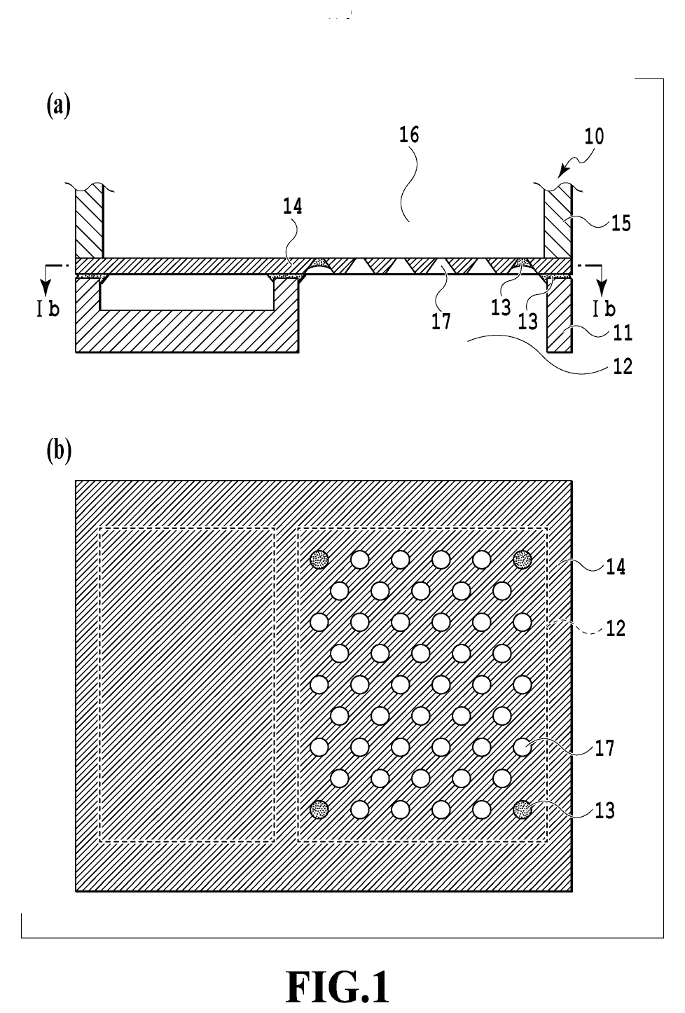

Embodiments of the flow path member according to the present disclosure will be described with reference to FIGS. 1-5.

### First Embodiment

A flow path member according to a first embodiment of the present disclosure will be described using FIG. 1.

A flow path member 10 has a first flow path 12 in a first substrate 11, a film member 14 joined to the first substrate 11 via an adhesive 13 so as to cover the first flow path 12, and a second flow path 16 in a second substrate 15 joined to the first substrate 11 via the film member 14. For the first substrate 11 and the second substrate 15, for example, a single crystal silicon substrate can be used. For the adhesive 13, for example, epoxy, acrylic, urethane, silicone, benzocyclobutene, polyimide, polyamide, polyamide-imide, cyanoacrylate, phenol resin, melamine resin, styrene resin, cyclized rubber, or a mixture thereof or the like can be used. The film member 14 may have flexibility, and in one embodiment may be a flexible film. For the film member 14, a resin member such as polyimide, polyamide, polyamide-imide, or epoxy can be used, for example. A film thickness of the film member 14 is, for example, 5 μm or less, and in one embodiment, the film thickness may be 3 μm or less. In the flow path member 10, a through hole 17 is formed in the film member 14, the first flow path 12 and the second flow path 16 communicate with each other by the through hole 17, and a liquid (not shown) flows from the first flow path 12 to the second flow path 16. An inner wall of the through holes 17 includes a region where a diameter becomes smaller from the first substrate 11 side toward the second substrate 15 side, and the through hole 17 is blocked by the adhesive 13 that has entered at least a part of the region. FIG. 1 (b) is a view of the flow path member 10 cut along Ib-Ib, and is a plan view of the film member 14 viewed from the second substrate 15 side. Among a plurality of the through holes 17, the adhesive 13 enters at least one or more through holes 17, and the through hole 17 is blocked by the adhesive 13. FIG. 1 (b) illustrates a case where the adhesive 13 enters the through holes 17 located at corners (for example, four corners) of a region (filter region) where a plurality of the through holes 17 are arranged, and these through holes 17 are blocked.

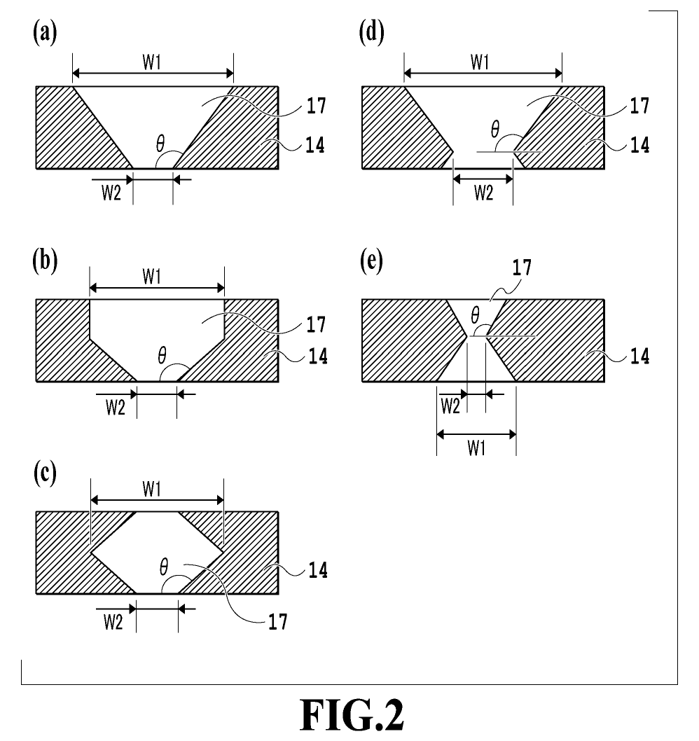

FIG. 2 shows an example of a cross-sectional shape of the through hole 17 of the film member 14. In FIG. 2, the first flow path 12 side of the film member 14 is the upper side of the drawing sheet, and the second flow path 16 side is the lower side of the drawing sheet. It is sufficient that the through hole 17 has a region where a diameter becomes smaller in a film thickness direction of the film member 14 as shown in FIG. 2. In the present embodiment, it is desirable that the diameter of the through hole 17 has a region that becomes smaller from the first flow path 12 side toward the second flow path 16 side. In FIG. 2, a value of a substantially maximum portion (maximum portion) of the diameter of the through hole 17 is indicated by W1, and a value of a substantially minimum portion (minimum portion) is indicated by W2. In this specification, the term "substantially" may be used. The word "substantially" means that there is a predetermined width in an upper limit or a lower limit of a term to which this is prefixed. Therefore, the term prefixed with "substantially" means including a surrounding range thereof in addition to the meaning or numerical value itself of the term. For example, the substantially maximum portion and the substantially minimum portion of the through hole mean a portion of the maximum diameter and a portion of the minimum diameter of the through hole, and the peripheries thereof, respectively. FIGS. 2 (a) to (e) are examples having the following features. FIG. 2 (a) shows an example in which the diameter of the through hole 17 continuously becomes smaller in the film thickness direction of the film member 14. Further, FIG. 2 (b) shows an example having a region where the diameter continuously becomes smaller from the middle of the through hole 17 in the film thickness direction. FIG. 2 (c) is an example having the value W1 of the substantially maximum portion (maximum portion) in the middle of the through hole 17 in the film thickness direction, and having the value W2 of the substantially minimum portion (minimum portion) on the second flow path 16 side of the film member 14. FIG. 2 (d) and FIG. 2 (e) are examples having the value W2 of the substantially minimum portion (minimum portion) in the middle of the through hole 17 in the film thickness direction. In FIG. 2 (d), there is the value W1 of the substantially maximum portion (maximum portion) on the first flow path side of the through hole 17, and in the present embodiment, in FIG. 2 (e), there is the value W1 of the substantially maximum portion (maximum portion) on the second flow path side of the through hole 17. As shown in FIG. 2 (e), the through hole 17 may have the value W2 of the substantially minimum portion (minimum portion) of the diameter in the direction of the second flow path 16, and may have the value W1 of the substantially maximum portion (maximum portion) in the direction of the first flow path 12. The value W2 of the substantially minimum portion (minimum portion) of the diameter of the through hole 17 is, for example, 50 μm or less, and in one embodiment, may be 30 μm or less. Further, the value W1 of the substantially maximum portion (maximum portion) of the diameter of the through hole 17 is, for example, 1.1 times or more of W2. A ratio (W1/W2) of the value W2 of the substantially minimum portion (minimum portion) and the value W1 of the substantially maximum portion (maximum portion) of the diameter of the through hole 17 can be 1.1 or more, in one embodiment, may be 1.1 or more and 3.0 or less, and in another embodiment, 1.1 or more and 2.0 or less. Further, it is desirable that the inner wall of the through holes 17 in the region where the diameter of the through hole 17 continuously becomes smaller has an inclination angle θ. The inclination angle θ is an angle between the inner wall of the through holes 17 and a hole surface on the second flow path 16 side of the through hole 17 or a surface parallel to the hole surface, as shown in FIG. 2. In one embodiment, the inclination angle can be an obtuse angle. The angle may be 135° or more, and it is suitable if the angle is 150° or more. By having such an angle, the flow path member 10 can support the adhesive 13 that has entered the through hole 17 from the downstream side (second flow path 16 side). Therefore, it is possible to suppress the surplus adhesive that has entered the through hole 17 of the filter of the flow path member 10 from peeling off and becoming a foreign matter in the liquid. Note that a planar shape (shape of the opening) of the through hole 17 may be, for example, a quadrangle or a polygon. In one embodimet, the planer shape can be a circle. Further, the inclination angle θ of the through hole 17 may not be point-symmetric, and the inclination angle may be partially different.

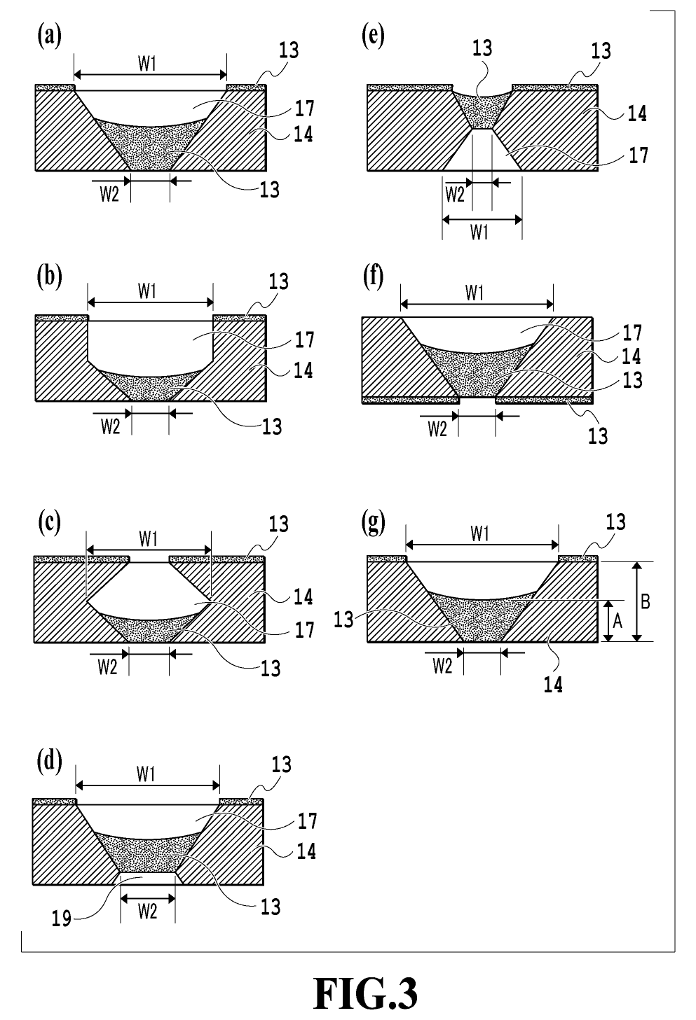

FIG. 3 shows an example of a cross-sectional shape of the adhesive 13 in the through hole 17. In FIG. 3, the first flow path 12 side of the film member 14 is the upper side of the drawing sheet, and the second flow path 16 side is the lower side of the drawing sheet. The through hole 17 has a region where the diameter becomes smaller in the film thickness direction of the film member 14, and the region including the value W2 of the substantially minimum portion (minimum portion) of the diameter of the through hole 17 is blocked by the adhesive 13. The adhesive 13 that has entered the inside of the through hole 17 is supported from the downstream side (second flow path side) by an inclined portion of the region where the diameter becomes smaller in the film thickness direction of the film member 14. As shown in FIGS. 3 (a) to (c), it is sufficient that the adhesive 13 in the through hole 17 is supported from the downstream side (second flow path side) by the region where the diameter of the through hole 17 continuously becomes smaller in the film thickness direction of the film member 14. These are examples having the value W2 of the substantially minimum portion (minimum portion) of the diameter of the through hole 17 on the surface on the second flow path 16 side of the film member 14 (downstream surface of the film member 14). Further, as shown in FIG. 3 (d), the adhesive 13 in the through hole 17 may be supported from the downstream side (second flow path 16 side) by a region where the diameter continuously becomes smaller halfway in a depth direction of the through hole 17. In this case, as shown in FIG. 3 (d), a side 19 downstream (second flow path 16 side) of the value W2 of the substantially minimum portion (minimum portion) of the diameter of the through hole 17 does not have to be blocked by the adhesive 13. Further, FIG. 3 (e) is a configuration having the value W2 of the substantially minimum portion (minimum portion) of the diameter on the upstream side (first flow path 12 side) of the through hole 17, and having the value W1 of the substantially maximum portion (maximum portion) on the downstream side (second flow path 16 side). Also in this configuration, it is sufficient that the adhesive 13 in the through hole 17 is supported from the downstream side (second flow path 16 side) by the region where the diameter continuously becomes smaller halfway in the depth direction of the through hole 17. Further, a bonding surface between the film member 14 and the first substrate 11 (not shown) may be on the upstream side (first flow path 12 side) as shown in FIGS. 3 (a) to (e), or may be on the downstream side (second flow path 16 side) as shown in FIG. 3 (f). Even in the case as shown in FIG. 3 (f), it is sufficient that the adhesive 13 in the through hole 17 is supported from the downstream side by the region where the diameter of the through hole 17 continuously becomes smaller. Further, as shown in FIG. 3 (g), regarding the adhesive 13 that has entered the through hole 17 of the film member 14, it is desirable that a film thickness A of the adhesive 13 in the depth direction of the through hole 17 and a film thickness B of the film member satisfy A/B ≥ 1/3, and in one embodiment, may satisfy A/B ≥ 1/2. Note that the film thickness A of the adhesive 13 is a substantially minimum value (minimum value) of the film thickness of the adhesive 13 that has entered the inside of the through hole 17. In such a case, since a region supported from the downstream side by the region where the diameter of the through hole 17 continuously becomes smaller in the film thickness direction of the film member 14 increases, the adhesive 13 is further suppressed from being pushed out to the downstream side of the through hole 17 by the liquid flow. Note that the film thickness B of the film member 14 can be, for example, 5 μm or less, and in one embodiment, may be 3 μm or less.

As described above, the flow path member according to the present disclosure includes: a first substrate having a first flow path; a second substrate having a second flow path and stacked on the first substrate; a film member arranged between the first substrate and the second substrate, in which a plurality of through holes that allow the first flow path and the second flow path to communicate with each other are included; and an adhesive that adheres the first substrate and the film member, in which a liquid flows from the first flow path to the second flow path via the through holes, in which an inner wall of the through holes includes a region where a diameter becomes smaller from the first substrate side toward the second substrate side, and in which at least one through hole among the plurality of through holes is blocked by the adhesive that has entered at least a part of the region. More specifically, the flow path member includes: a first substrate provided with a first flow path; a film member joined to the first substrate via an adhesive so as to cover the first flow path; and a second substrate joined to the first substrate via the film member and provided with a second flow path, in which a through hole is formed in the film member, the first flow path and the second flow path communicate with each other by the through hole, and a liquid flows from the first flow path to the second flow path, in which an inner wall of the through holes includes a region where a diameter becomes smaller from the first substrate side toward the second substrate side, and in which the through hole is blocked by the adhesive that has entered at least a part of the region.

Therefore, according to the present disclosure, it is possible to provide a flow path member that suppresses a surplus adhesive that has entered a filter through hole of the flow path member from peeling off and becoming a foreign matter in a liquid.

### Second Embodiment (Manufacturing Method of Flow Path Member)

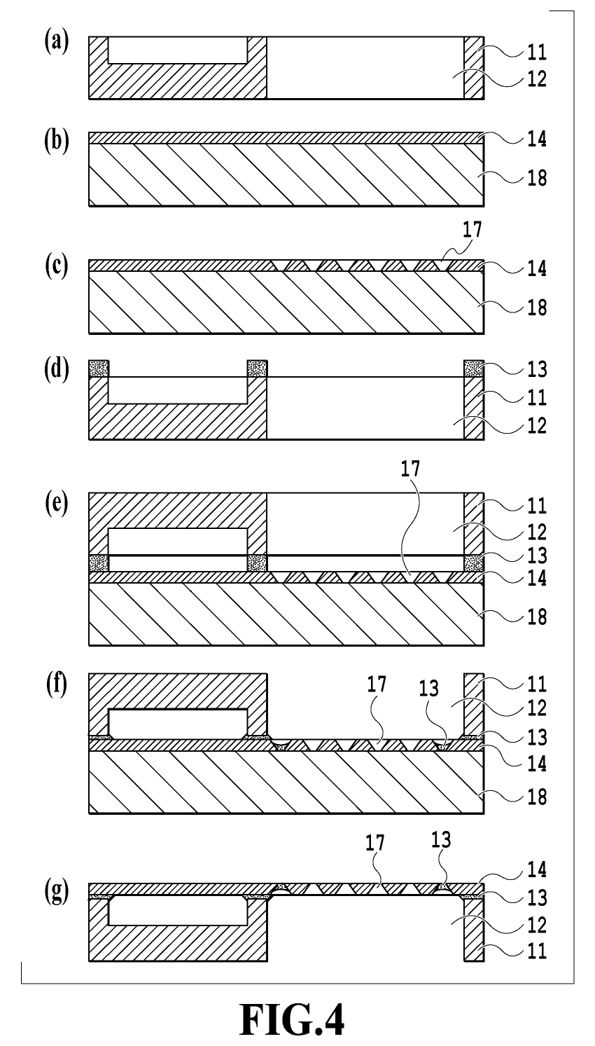

A manufacturing method of a flow path member according to a second embodiment of the present disclosure will be described using cross-sectional views of FIGS. 4 (a) to (g). The flow path member 10 can be manufactured according to the procedure shown in FIGS. 4 (a) to (g).

As shown in FIG. 4 (a), a first substrate 11 having a first flow path 12 is prepared. For the first substrate 11, for example, a single crystal silicon substrate can be used, and a thickness of the substrate is, for example, 725 μm.

As shown in FIG. 4 (b), a support substrate 18 having a film of a film member 14 formed on one of surfaces thereof is prepared. For the support substrate 18, for example, a single crystal silicon substrate may be used, and a substrate thickness is, for example, 725 μm. In the film member 14, a material including a resin member such as polyimide, polyamide, polyamide-imide, or epoxy is formed on the support substrate 18, for example. An adhesion improver (not shown) may be formed between the film member 14 and the support substrate 18. Note that a protective film (not shown) such as an oxide film or a nitride film may be formed between the support substrate 18 and the film member 14, for example.

As shown in FIG. 4 (c), a plurality of through holes 17 are formed in the film member 14. The through hole 17 is formed so as to penetrate the film member 14. Formation of the through hole 17 is performed such that an inner wall of the through holes 17 has a region where a diameter becomes smaller toward the support substrate 18. The through hole 17 can be formed by dry etching the film member 14 using an etching mask (not shown) made of, for example, a photoresist. In order to form the through hole 17 in the above-described shape, in a case of dry etching, isotropic etching may be performed by setting a pressure during etching to a value between 20 Pa or more and 70 Pa or less, for example. Further, it may be performed by making an etching selection ratio between the etching mask (not shown) and the film member 14 lower than 1, and for example, in one embodiment, the etching selection ratio can be 0.5 or less. For an etching gas, for example, oxygen may be used, or a mixed gas of oxygen and tetrafluoromethane may be used. After the formation of the through hole 17, the etching mask (not shown) is removed. In a case where the etching mask is a photoresist, the etching mask can be removed by, for example, treatment with a resist stripping solution.

As shown in FIG. 4 (d), an adhesive 13 is applied to the surface of the first substrate 11. For application of the adhesive 13, for example, a dispensing method, a screen printing method, a method of transferring the adhesive 13 formed into a dry film, or the like can be used. For the adhesive 13, for example, epoxy, acrylic, urethane, silicone, benzocyclobutene, polyimide, polyamide, polyamide-imide, cyanoacrylate, phenol resin, melamine resin, styrene resin, cyclized rubber, or a mixture thereof or the like can be used.

As shown in FIG. 4 (e), the first substrate 11 and the support substrate 18 on which the film member 14 is formed are aligned using alignment marks (not shown) so that the plurality of through holes 17 formed in the film member 14 are positioned directly above the first flow path 12.

Next, as shown in FIG. 4 (f), the first substrate 11 and the support substrate 18 on which the film member 14 is formed are pressurized and joined, and are brought into contact via the adhesive 13. A surplus portion of the adhesive 13 protrudes from a joining interface and enters at least one or more through holes 17 among the plurality of through holes 17 of the film member 14. At this time, since the film member 14 is supported by the support substrate 18, the adhesive 13 that has entered the through hole 17 blocks the through hole 17. Since the through hole 17 has a region where the diameter becomes smaller toward the support substrate 18, the adhesive 13 easily enters to the bottom of the through hole 17, and the through hole 17 is blocked by the adhesive 13. Next, the adhesive 13 is cured. In a case where the adhesive 13 is, for example, a thermosetting adhesive, heat treatment may be performed to cure the adhesive. Next, as shown in FIG. 4 (g), the support substrate 18 is removed. Thereby, the flow path member 10 as shown in FIG. 4 (g) can be manufactured. Note that for removal of the support substrate 18, for example, dry etching, wet etching, grinding processing, or the like can be used, and a method combining these can also be used. Next, by bonding a second substrate 15 having a second flow path 16 to the film member 14, for example, the flow path member 10 as shown in FIG. 1 (a) can be manufactured. In the flow path member 10, the adhesive 13 that has entered the inside of the through hole 17 blocks the region where the diameter becomes smaller in the film thickness direction of the film member 14, and is supported from the downstream side (second flow path side) by the inclined portion thereof. For this reason, the adhesive 13 that has entered the inside of the through hole 17 is suppressed from flowing to the downstream side (second flow path side) of the film member 14.

As described above, the manufacturing method of a flow path member according to the present disclosure is a manufacturing method of a flow path member including: preparing a first substrate having a first flow path; forming a film member on a support substrate, including forming a plurality of through holes having a region where a diameter becomes smaller toward the support substrate in the film; applying an adhesive to the first substrate and pasting the first substrate and the film member on the support substrate via the adhesive; curing the adhesive; and removing the support substrate, in which in pasting the film member, the through hole is blocked by the adhesive that has entered at least a part of the region. More specifically, the manufacturing method of a flow path member according to the present disclosure is a manufacturing method of a flow path member including: preparing a first substrate having a first flow path; preparing a support substrate on which a film member is formed; forming a plurality of through holes having a region where a diameter becomes smaller toward the support substrate in the film member; applying an adhesive to the first substrate; pasting the first substrate and the film member via the adhesive with the plurality of through holes facing the first flow path; curing the adhesive; and removing the support substrate, in which in pasting the film member, the through hole is blocked by the adhesive that has entered at least a part of the region. Therefore, according to the present disclosure, it is possible to provide a manufacturing method of a flow path member that suppresses a surplus adhesive that has entered a filter through hole of the flow path member from peeling off and becoming a foreign matter in a liquid.

### Third Embodiment (Liquid Ejection Head

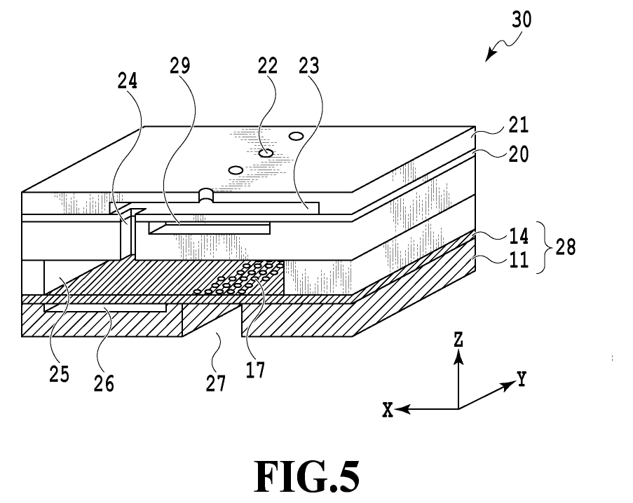

A liquid ejection head using a flow path member according to a third embodiment of the present disclosure will be described using a perspective view of FIG. 5. A liquid ejection head 30 has a plurality of pressure chambers 23 respectively communicating with a plurality of ejection ports 22, and a plurality of individual flow paths 24 respectively communicating with the plurality of pressure chambers 23. On a surface of the plurality of individual flow paths 24 facing a surface having the pressure chambers, there is a common flow path 25 (the common flow path 25 corresponds to the second flow path 16 of the second substrate of the first embodiment) communicating with the plurality of individual flow paths 24. Further, the liquid ejection head 30 has a film member 14 adhered via an adhesive (not shown) between the common flow path 25 and grooves 26 wherein the grooves 26 are covered by the film member extending along an array direction of the individual flow paths 24. In the liquid ejection head 30, a liquid (not shown) passes from a liquid supply flow path 27 (the liquid supply flow path 27 corresponds to the first flow path 12 of the first substrate of the first embodiment) through a plurality of through holes 17 formed in the film member 14. The liquid is filtered by passing through the through holes, passes through the common flow path 25, and is supplied to the pressure chamber 23 via the individual flow path 24. The liquid ejection head 30 causes a vibration plate 20 to be displaced by a piezoelectric element 29 installed via the vibration plate 20 at a position facing the pressure chamber 23. Due to this displacement, volume of the pressure chamber 23 is varied, and thereby the liquid is ejected from the ejection port 22. The film member 14 functions as a damper for suppressing vibration of the vibration plate 20 from being transmitted to the adjacent pressure chamber 23 through the liquid in the common flow path 25 during ejection of the liquid, and also functions as a filter for the liquid supplied from the liquid supply flow path 27 to the common flow path 25. In the liquid ejection head 30 according to the present embodiment, a flow path member 28 in which the film member 14 having the plurality of through holes 17 covering the liquid supply flow path 27 is adhered with an adhesive (not shown) is used. An inner wall of the through holes 17 includes a region where a diameter becomes smaller from the liquid supply flow path 27 side toward the common flow path 25 side (from the first flow path of the first substrate toward the second flow path of the second substrate). Then, the through hole 17 has, for example, the shape described in the first embodiment, and is blocked by the adhesive that has entered a region in at least a part of the through holes 17. For this reason, the adhesive that has entered the inside of the through hole 17 is supported from the downstream side (common flow path 25 side) by an inclined portion of the region where the diameter becomes smaller in the film thickness direction of the film member 14. Therefore, the adhesive that has entered the through hole 17 is suppressed from flowing to the downstream side due to the liquid flow. Further, in the liquid ejection head 30, even if a recovery operation by pressurization and suction is performed, the adhesive that has entered the inside of the through hole 17 is suppressed from flowing to the downstream side (common flow path 25 side) for the same reason as described above. For this reason, the liquid ejection head 30 can suppress a liquid ejection failure caused by a surplus adhesive that has entered an opening (through hole 17) of a filter of the flow path member peeling off and becoming a foreign matter in the liquid.

As described above, the liquid ejection head of the present disclosure includes: a plurality of ejection ports; a first substrate having a first flow path; a second substrate including a second flow path communicating with the plurality of ejection ports; a film member arranged between the first substrate and the second substrate, in which a plurality of through holes that allow the first flow path and the second flow path to communicate with each other are included; and an adhesive that adheres the first substrate and the film member, and includes a flow path member in which a liquid flows from the first flow path to the second flow path via the through holes, wherein an inner wall of the through holes includes a region where a diameter becomes smaller from the first substrate side toward the second substrate side, and wherein at least a part of through holes among the through holes are blocked by the adhesive that has entered at least a part of the region. More specifically, the liquid ejection head of the present disclosure is a liquid ejection head comprising: a plurality of ejection ports; a plurality of pressure chambers respectively communicating with the plurality of ejection ports; a plurality of individual flow paths respectively communicating with the plurality of pressure chambers; and a flow path member in which a common flow path communicating with the plurality of individual flow paths, a liquid supply flow path for supplying a liquid to the common flow path, and a film member having a plurality of through holes covering the liquid supply flow path and adhered with an adhesive are provided on a facing surface of the plurality of individual flow paths, in which an inner wall of the through holes includes a region where a diameter becomes smaller from the liquid supply flow path side toward the common flow path side, and in which the through hole is blocked by the adhesive that has entered at least a part of the region.

Therefore, according to the present disclosure, it is possible to provide a liquid ejection head that suppresses a liquid ejection failure caused by a surplus adhesive that has entered an opening (through hole) of a filter of a flow path member peeling off and becoming a foreign matter in a liquid.

### Examples

### Example 1

A flow path member according to a first example of the present disclosure will be described using FIG. 1.

A film thickness of a film member 14 of the flow path member was 3 μm, and polyimide was used for a material. A minimum portion (substantially minimum portion) of a diameter of a through hole is located further on a downstream side (second flow path side) than a maximum portion (substantially maximum portion), and the minimum portion of the diameter of the through hole is located at the most downstream portion. A diameter of the maximum portion of the through hole was 40 μm in width, and a diameter of the minimum portion of the through hole was 30 μm in width. An angle (θ) formed by the minimum portion and an inner wall of the through holes was about 150°. Among a plurality of through holes, in openings at corner portions of a filter region, the adhesive blocked the through holes with a thickness of about 2 μm. In the case where this flow path member was used as a filter of a liquid ejection head, as described above, the adhesive blocking the filter through hole was suppressed from becoming a cause of a liquid ejection failure on the filter downstream side (second flow path side), and functioned as a filter. Therefore, according to the present disclosure, it was possible to provide a flow path substrate in which a surplus adhesive that has entered a through hole of a filter of a flow path member is suppressed from becoming a foreign matter in a liquid on a filter downstream side (second flow path side).

### Example 2

Regarding a manufacturing method of a flow path member according to a second embodiment of the present disclosure, a flow path member was manufactured by a method similar to the method shown in the second embodiment as shown in FIG. 4. Characteristics such as material and dimensions of each member of the flow path member were the same as those in Example 1. Since an adhesive 13 that had entered the inside of a through hole 17 was supported from a downstream side (second flow path side) by an inclined portion of a region where a diameter became smaller in a film thickness direction of a film member 14, flowing to the downstream side due to a liquid flow was suppressed.

In the case where the flow path member of this example was used as a filter, as described above, the adhesive blocking the filter through hole was suppressed from becoming a cause of a liquid ejection failure on the filter downstream side (second flow path side), and functioned as a filter. Therefore, according to the present disclosure, it was possible to provide a manufacturing method of a flow path member in which a surplus adhesive that has entered a filter through hole of the flow path member is suppressed from becoming a foreign matter in a liquid on a filter downstream side.

### Example 3

A liquid ejection head according to a third example of the present disclosure will be described using FIG. 5. A liquid ejection head 30 has a flow path member 28 as described in the third embodiment. The flow path member 28 has the configuration described in the first embodiment. With respect to the liquid ejection head 30, after recovery by pressurization and suction processing, a liquid (not shown) was ejected. As a result of ejection, the liquid (not shown) was able to be ejected normally, and the adhesive blocking the through hole of the filter was suppressed from becoming a cause of a liquid ejection failure on the filter downstream side (second flow path side). Therefore, according to the present disclosure, it was possible to provide a liquid ejection head in which a surplus adhesive that has entered a through hole of a filter of a flow path member is suppressed from becoming a foreign matter in a liquid on a filter downstream side (second flow path side).

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to suppress a surplus adhesive that has entered a through hole of a filter of a flow path member from peeling off and becoming a foreign matter in a liquid.

This application claims the benefit of Japanese Patent Application No. 2025-076854, filed May 2, 2025, which is hereby incorporated by reference herein in its entirety.

What is claimed is:

1. A flow path member comprising:
a first substrate having a first flow path;
a second substrate having a second flow path and stacked on the first substrate;
a film member arranged between the first substrate and the second substrate, in which a plurality of through holes that allow the first flow path and the second flow path to communicate with each other are inlcuded; and
an adhesive that adheres the first substrate and the film member, wherein
a liquid flows from the first flow path to the second flow path via the through holes,
an inner wall of the through holes includes a region where a diameter becomes smaller from the first substrate side toward the second substrate side, and
at least one through hole among the plurality of through holes is blocked by the adhesive that has entered at least a part of the region.

2. The flow path member according to claim 1, wherein the film member is a flexible film.

3. The flow path member according to claim 2, wherein in the region where the diameter of the through hole becomes smaller, an angle between a hole surface of the through hole and the inner wall is 150° or more.

4. The flow path member according to claim 3, wherein in the region where the diameter of the through hole becomes smaller, a position of a minimum portion of the diameter is a portion adjacent to the second flow path side of the through hole.

5. The flow path member according to claim 4, wherein in the region where the diameter of the through hole becomes smaller, a value of a diameter of the minimum portion is 30 μm or less.

6. The flow path member according to claim 1, wherein a ratio (W1/W2) of a value W1 of a diameter of a maximum portion and a value W2 of a diameter of a minimum portion of the through hole is 1.1 or more.

7. The flow path member according to claim 6, wherein the ratio (W1/W2) of the value W1 of the diameter of the maximum portion and the value W2 of the diameter of the minimum portion of the through hole is 1.1 or more and 3.0 or less.

8. The flow path member according to claim 1, wherein if a film thickness of the adhesive that has entered the through hole is A and a film thickness of the film member is B, A/B ≥ 1/3 is satisfied.

9. The flow path member according to claim 8, wherein the film thickness of the film member is 3 μm or less.

10. The flow path member according to claim 9, wherein the film member is polyimide.

11. A manufacturing method of a flow path member, comprising:
preparing a first substrate having a first flow path;
forming a film member on a support substrate, including forming a plurality of through holes having a region where a diameter becomes smaller toward the support substrate in the film;
applying an adhesive to the first substrate and attaching the first substrate and the film member on the support substrate via the adhesive;
curing the adhesive; and
removing the support substrate, wherein
in attaching the film member, the through hole is blocked by the adhesive that has entered at least a part of the region.

12. The manufacturing method of a flow path member according to claim 11, wherein the step of forming the plurality of through holes is performed using an etching mask, and an etching selection ratio between the etching mask and the film member is 0.5 or less in a case where the plurality of through holes is formed.

13. A liquid ejection head comprising:
a plurality of ejection ports;
a first substrate having a first flow path;
a second substrate including a second flow path communicating with the plurality of ejection ports;
a film member arranged between the first substrate and the second substrate, in which a plurality of through holes that allow the first flow path and the second flow path to communicate with each other are included; and
an adhesive that adheres the first substrate and the film member,
including a flow path member in which a liquid flows from the first flow path to the second flow path via the through holes, wherein
an inner wall of the through holes includes a region where a diameter becomes smaller from the first substrate side toward the second substrate side, and
at least a part of through holes among the through holes are blocked by the adhesive that has entered at least a part of the region.

14. The liquid ejection head according to claim 13, wherein the through hole blocked by the adhesive is a through hole located at a corner of a region where the through holes are arranged.
